(19) United States
(12) Patent Application Publication
(10) Pub. No.: US 2004/0121772 A1
(43) Pub. Date: Jun. 24, 2004

(54) Method for supporting mobility of WLAN voice terminal

(76) Inventor: Seon-Soo Rue, Suwon-city (KR)

Correspondence Address: Robert E. Bushnell, Suite 300, 1522 K Street, N.W., Washington, DC, 20005, US

(21) Appl. No.: 10/733,683

(22) Filed: Dec. 12, 2003

(30) Foreign Application Priority Data
Dec. 16, 2002 (KR) 2002-80463

(51) Int. Cl. H04Q 7/20; H04M 1/00; H04B 1/38

(52) U.S. Cl. 455/436; 455/434; 455/426.2; 455/555; 455/550.1

(57) ABSTRACT

A method is for supporting mobility of a WLAN voice terminal which can guarantee mobility, when a data line such as an ISDN line is used as a communication line between a switching system and access points and when the WLAN voice terminal roams from a basic service set of one access point which it intends to be associated with to a basic service set of another access point during signaling. It also guarantees mobility when the WLAN voice terminal roams from a basic service set of one access point which it is currently associated with to a basic service set of another access point during an active call. The method for supporting mobility of a WLAN voice terminal using a data line, includes where the WLAN voice terminal roams to a second access point and performs a probe process during association signaling between the WLAN voice terminal and a first access point, where the WLAN voice terminal and the second access point perform a MAC address authentication process, where a circuit interface unit performs handover by using terminal information of the WLAN voice terminal and MAC address information of the first access point upon the re-association request of the WLAN voice terminal through the second access point, and where the WLAN voice terminal and the second access point perform an association signaling process after the handover.

### CLAIM OF PRIORITY

This application makes reference to, incorporates the same herein, and claims all benefits accruing under 35 U.S.C. §119 from an application for METHOD FOR THE REALIZATION OF MOBILITY BY USING WLAN VOICE TERMINAL AT THE ISDN SWITCHING SYSTEM earlier filed in the Korean Intellectual Property Office on 16 Dec. 2002 and there duly assigned Serial No. 2002-80463.

### BACKGROUND OF THE INVENTION

1. Field of the Invention

The present invention relates to a method for supporting mobility of a WLAN (Wireless LAN (Local Area Network)) voice terminal, and more particularly to, a method for supporting mobility of a WLAN voice terminal which can guarantee mobility, when a data line such as an ISDN (Integrated Services Digital Network) line is used as a communication line between a switching system and a plurality of access points and when the WLAN voice terminal roams from one access point to another.

2. Description of the Related Art

General information terminals such as personal computers (PC), notebook computers and personal digital assistants (PDA) compose a LAN (Local Area Network) to share information. The LAN is classified into a LAN configured by directly connecting the information terminals through a communication cable, and a wireless LAN (WLAN) configured according to a wireless communication method using access points.

The WLAN performs data transmission/reception according to the wireless communication method by using RF (Radio Frequency) signals or lights, to provide mobility and simplify maintenance/repair works. The WLAN includes a wire processing unit and a wireless processing unit.

The wire processing unit provides 10/100 BASE-T Ethernet interface function of IEEE (Institute of Electrical and Electronics Engineers) 802.3, and the wireless processing unit provides a data transmission speed of 2 Mbps (megabits per second) in 2.4 GHz (gigahertz) frequency band of IEEE 802.11.

The WLAN has been continuously improved and generally used in large-scaled industrial facilities such as offices, retail shops, warehouses and factories. The WLAN embodies data transmission among computers, printers, servers and other devices without requiring efforts or expenses for installing wires and cables.

On the other hand, a voice communication network of internal offices and branch offices of a company has been built based on an IP due to rapid development of VoIP (Voice over IP (Internet protocol)) technologies for transmitting/receiving voice and data through an IP network. When the voice communication network is built on the basis of the IP, installation expenses of the network can be remarkably cut down, maintenance/repair works of the network can be simplified, and other supplementary services can be easily provided.

An IP-PBX (Internet Protocol-Private Branch exchange) replacing general PBX-based interphone networks of a company by IP-based ones is an example of applying a voice/data integration technology into an interphone system. By using the IP-PBX, all interphones are replaced by IP-phones supporting VoIP function, and a VoIP gateway is installed in the interface of the company and an external PSTN to relay calls transmitted/received to/from the external PSTN. In addition, international calls, long distance calls, and calls between the main office and branches are connected through an external Internet, to reduce communication expenses.

However, although the IP-PBX system is very advantageous in installation, maintenance/repair and communication expenses of the interphone networks, it does not improve convenience of users more than the general PBX-based interphone system.

Therefore, there has been suggested a system building a voice communication network based on an IP within a company and using a PSTN outside the company according to the WLAN and IP-PBX technologies.

FIG. 1 is a view illustrating a general WLAN environment using an Ethernet between a switching system and access points.

As illustrated in FIG. 1, the WLAN environment includes a switching system 110 connected physically and functionally to a PSTN (Public Switched Telephone Network) and an IP network line, for transmitting switched signals to each line, access points 120a and 120b for transmitting VoIP call connection requests of WLAN voice terminals 130a, 130b and 130c to the switching system 110 through an Ethernet shared line, and also transmitting VoIP calls of the switching system 110 to the WLAN voice terminals 130a, 130b and 130c, and the WLAN voice terminals 130a, 130b and 130c which are information terminals used by WLAN users. The access points 120a and 120b and the switching system 110 are connected through the Ethernet shared line.

Here, the switching system 110 transforms the VoIP call connection requests of the WLAN voice terminals 130a, 130b and 130c into signals suitable for the PSTN, and also transforms signals of the PSTN into the VoIP calls and transmits them to the WLAN voice terminals 130a, 130b and 130c.

That is, the PSTN showing high quality of voice is used as an external communication line of a company, and an IP network supporting VoIP is used within the company to support the WLAN voice terminals 130a, 130b and 130c.

The access points 120a and 120b which are WLAN access devices for supporting interworking of a general LAN service area and a WLAN service area include at least one Ethernet MAC (Media Access Control) and WLAN MAC. According to the definition of the WLAN MAC in IEEE 802.11, the access points 120a and 120b pass through authentication and association to manage their WLAN service area.

When the WLAN voice terminals 130a, 130b and 130c request call connection, the access points 120a and 120b receive call connection information, namely IP, gateway and DNS (Domain Name Server) information previously-set in the WLAN voice terminals 130a, 130b and 130c from the WLAN voice terminals 130a, 130b and 130c, request authentication to the switching system 110, and perform a WLAN relay function for call connection.

Here, the WLAN voice terminals 130a, 130b and 130c input their identifiers and passwords to obtain authentication for call connection from the switching system 110. When the switching system 110 authenticates call connection of the WLAN voice terminals 130a, 130b and 130c, the WLAN voice terminals 130a, 130b and 130c build a wireless network through the access points 120a and 120b, and perform call connection through the switching system 110.

On the other hand, in order to roam from one access point to another, the WLAN voice terminals perform an operation (scanning) for tracking an access point which they can transmit a probe request frame to, receive a probe response frame from, and be associated with. Here, the roaming operation implies communication association switching from one access point to another.

A general scan is divided into two types of scans in default, an active mode scan and a passive mode scan. The active mode scan is first executed. When the access point is not tracked in a BSS (Basic Service Set), the scanning mode is switched into the passive mode scan, and the passive mode scan is executed. When the access point is not tracked by the passive mode scan, the active mode scan and the passive mode scan are repeated.

All channels must be scanned according to the scanning operation in order to track accessible access points. The roaming operation is performed by transmitting an authentication request frame (frame for requesting association of WLAN voice terminal and access point, IEEE802.11) to an initial access point according to the scanning operation of the WLAN voice terminal, and receiving an authentication response frame notifying that the access point has authenticated the WLAN voice terminal from the access point.

In the roaming system, the WLAN voice terminals are disassociated from the current access point, scan all accessible access points, and are associated with the access point having the highest RSSI (Receive Signal Structure Indicator).

However, when the switching system and the access points are connected through the Ethernet shared line, the Ethernet has difficulty in supplying power from the switching system to the respective access points. Therefore, each access point require a power adapter.

In addition, when the switching system and the access points are connected through the Ethernet shared line, quality of voice is varied by the status of the Ethernet (influenced by various devices connected to the Ethernet).

In order to solve the foregoing problems, there has been disclosed a WLAN which can connect a switching system to access points through a data line such as an ISDN line for supplying power, without using special power adapters in the access points.

Moreover, the WLAN using the data line such as the ISDN line as a communication line can directly transmit data between the access points and the switching system, and thus is less influenced by various factors than the Ethernet environment, to improve quality of voice.

A lot of advantages are obtained by using the data line such as the ISDN line as the communication line between the access points and the switching system.

The general WLAN environment using the Ethernet employs the VoIP. When the WLAN voice terminals roam on the IP and have the same destination IP, if they roam between the access points, a final destination IP of the IP packets is not changed. Accordingly, the IP packets always reach the same WLAN voice terminal, and thus mobility is guaranteed in the same subnet. However, when the data line such as the ISDN line is used between the switching system and the access points, the access points cannot transmit IP packets to each other. As a result, when the WLAN voice terminals roam from the BSS of one access point to the BSS of another access point, mobility is not supported.

### SUMMARY OF THE INVENTION

It is, therefore, an object of the present invention to provide a method for supporting mobility of a WLAN voice terminal which can guarantee mobility, when a data line such as an ISDN line is used as a communication line between a switching system and access points and when the WLAN voice terminal roams from a basic service set of one access point which it intends to be associated with to a basic service set of another access point during signaling.

Another object of the present invention is to provide a method for supporting mobility of a WLAN voice terminal which can guarantee mobility, when a data line such as an ISDN line is used as a communication line between a switching system and access points and when the WLAN voice terminal roams from a basic service set of one access point which it is currently associated with to a basic service set of another access point during an active call.

To achieve the above and other objects, there is provided a method for supporting mobility of a WLAN voice terminal using a data line, including: a first step where the WLAN voice terminal roams to a second access point and performs a probe process during association signaling between the WLAN voice terminal and a first access point; a second step where the WLAN voice terminal and the second access point perform a MAC address authentication process; a third step where a circuit interface unit performs handover by using terminal information of the WLAN voice terminal and MAC address information of the first access point upon the re-association request of the WLAN voice terminal through the second access point; and a fourth step where the WLAN voice terminal and the second access point perform an association signaling process after the handover.

There is also provided a method for supporting mobility of a WLAN voice terminal using a data line, including: a first step where the WLAN voice terminal roams to a second access point and performs a probe process during an active call between the WLAN voice terminal and a first access point; a second step where the WLAN voice terminal and the second access point perform a MAC address authentication process; a third step where a circuit interface unit performs handover by using terminal information of the WLAN voice terminal and MAC address information of the first access point upon the re-association request of the WLAN voice terminal through the second access point; a fourth step where the WLAN voice terminal and the second access point perform an association signaling process after the handover of the third step; and a fifth step where the second access point sets up a call and provides voice communication after the association signaling process.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a view illustrating a general WLAN environment using an Ethernet between a switching system and access points;

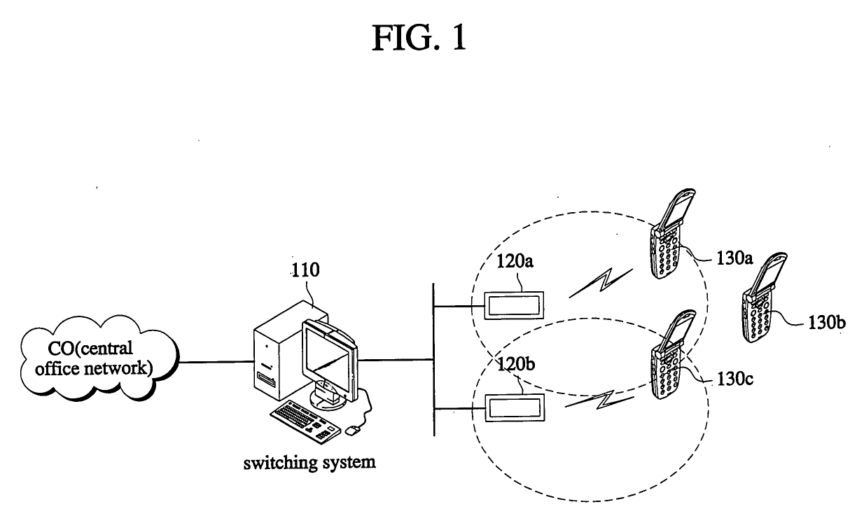

FIG. 2 is a view illustrating a WLAN environment using an ISDN line between a switching system and access points which the present invention is applied to;

FIG. 3 is a structure view illustrating a circuit interface unit mounted on the switching system of FIG. 2;

FIG. 4 is a signal flowchart showing a method for supporting mobility of a WLAN voice terminal when it roams between the access points during signaling in accordance with the present invention;

FIG. 5 is a signal flowchart showing the method for supporting mobility of the WLAN voice terminal when it roams between the access points during an active call in accordance with the present invention; and

FIG. 6 shows an example of a computer including a computer-readable medium having computer-executable instructions for performing a method of the present invention.

### DETAILED DESCRIPTION OF THE PREFERRED EMBODIMENTS

A preferred embodiment of the present invention will now be described with reference to the accompanying drawings. In the following description, same drawing reference numerals are used for the same elements even in different drawings. The matters defined in the description such as a detailed construction and elements of a circuit are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

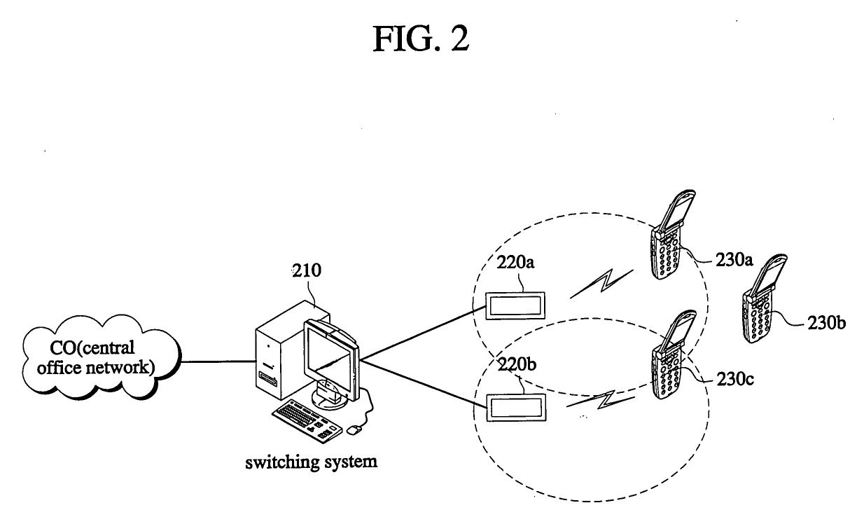

FIG. 2 is a view illustrating a WLAN environment using an ISDN line between a switching system and access points which the present invention is applied to.

As illustrated in FIG. 2, the WLAN environment includes a switching system 210, a plurality of access points 220a and 220b, and a plurality of WLAN voice terminals 230a, 230b and 230c.

The switching system 210 manages the plurality of access points 220a and 220b and the plurality of WLAN voice terminals 230a, 230b and 230c, and has mobility and call management functions.

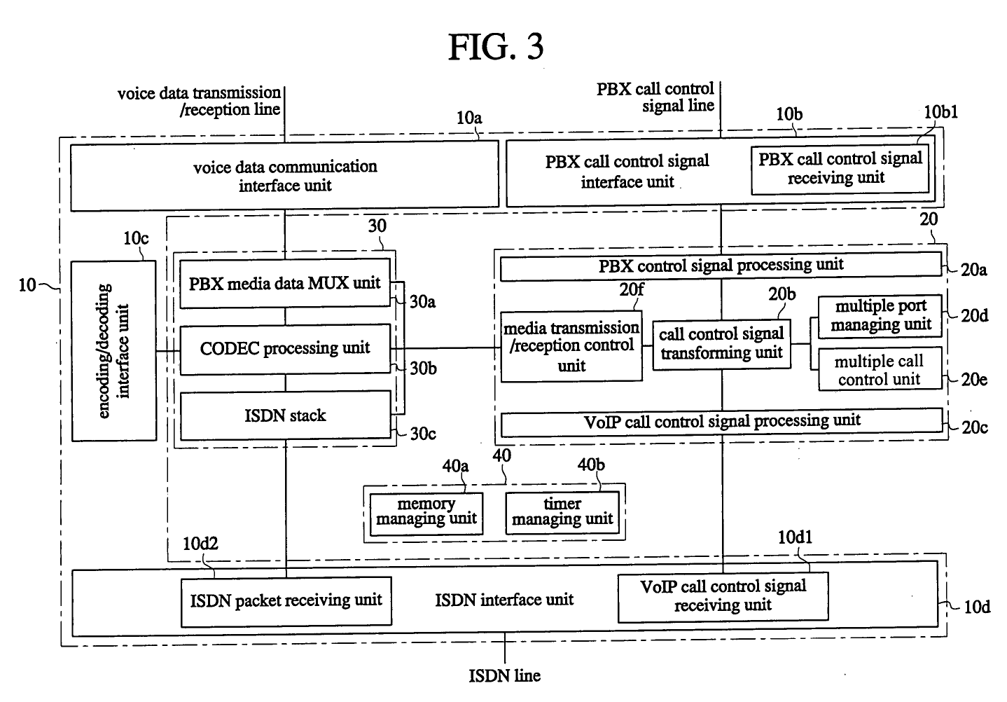

In addition, the switching system 210 manages information of the access points 220a and 220b and the WLAN voice terminals 230a, 230b and 230c, and performs data path switching and IP distribution. As shown in FIG. 3, the switching system 210 having a circuit interface unit inside or outside transmits voice data from the circuit interface unit to a PSTN, and voice data from the PSTN to the circuit interface unit.

The switching system 210 also provides mobility of the WLAN voice terminals 230a, 230b and 230c in the access points 220a and 220b through the circuit interface unit.

The access points 220a and 220b are internetworking devices for connecting the WLAN to the switching system 210. The access points 220a and 220b re-transmit overheard WLAN data pointed to a wire node to the switching system 210 through a data line such as an ISDN line, and also re-transmit ISDN data pointed to the WLAN voice terminals 230a, 230b and 230c to the WLAN.

That is, the internetworking service includes message re-transmission from the WLAN voice terminals 230a, 230b and 230c to the ISDN node, and message re-transmission from the ISDN node to the WLAN voice terminals 230a, 230b and 230c.

A physical area to which the WLAN voice terminals 230a, 230b and 230c must belong so as to exist within the access points 220a and 220b is called a BSA (Basic Service Area) of the access points 220a and 220b. If the WLAN voice terminals 230a, 230b and 230c exist in specific access points 220a and 220b, they can receive signals from the access points 220a and 220b.

The access points 220a and 220b physically connected to the data line such as the ISDN line supply power through the data line, instead of using special power adapters like the general access points connected to the LAN.

The access points 220a and 220b regularly transmit their own information to the WLAN voice terminals 230a, 230b and 230c in a beacon type so that the WLAN voice terminals 230a, 230b and 230c can distinguish their network addresses, and the WLAN voice terminals 230a, 230b and 230c confirm which BSA of the access points 220a and 220b they exist in according to the regular data transmission or beacons from the access points 220a and 220b.

The respective access points 220a and 220b maintain tables of all associated WLAN voice terminals 230a, 230b and 230c, namely basic set service (BSS) tables.

When successfully receiving association requests from the WLAN voice terminals 230a, 230b and 230c, the access points 220a and 220b add network node addresses of the WLAN voice terminals 230a, 230b and 230c to their BSS tables.

When the association requests show that the WLAN voice terminals 230a, 230b and 230c have been associated with another access points 220a and 220b, the access points 220a and 220b enable the switching system 210 to transmit disassociation data packets to the previous access points 220a and 220b through the data line such as the ISDN line.

When receiving the disassociation data packets from the switching system 210, the previous access points 220a and 220b delete network node addresses of the WLAN voice terminals 230a, 230b and 230c from their BSS tables.

In addition, when the access points 220a and 220b fail to transmit data to the WLAN voice terminals 230a, 230b and 230c, they regard it as disassociation from the WLAN voice terminals 230a, 230b and 230c, and delete the WLAN voice terminals 230a, 230b and 230c from their BSS tables.

On the other hand, the WLAN voice terminals 230a, 230b and 230c indicate information terminals having PCMCIA (Personal Computer Memory Card International Association) ports, USB (Universal Serial Bus) ports, PCI (Peripheral Component Interconnection) slots or EISA (Extended Industry Standard Architecture) slots, such as notebook computers, personal computers, personal digital assistants or personal communication systems on which WLAN cards are mounted to receive WLAN services.

The WLAN voice terminals 230a, 230b and 230c which intend to receive the WLAN service request association to the access points 220a and 220b by transmitting radio signals including a security function showing their coding types according to the WLAN standards such as IEEE 802.11.

The WLAN voice terminals 230a, 230b and 230c track the access points 220a and 220b, and maintain the tracked access points 220a and 220b in access point tables.

When the WLAN voice terminals 230a, 230b and 230c receive data packets from the access points 220a and 220b, they transmit association requests to the access point 220a and 220b to be associated with the access points 220a and 220b.

When the WLAN voice terminals 230a, 230b and 230c fail to be associated with the specific access points 220a and 220b, they preferably attempt to be associated with another access points of their access tables.

FIG. 3 is a structure view illustrating the circuit interface unit mounted on the switching system of FIG. 2.

As illustrated in FIG. 3, the circuit interface unit mounted on the switching system of FIG. 2 includes an interface unit 1 0 connected physically and functionally to the PSTN and the ISDN line, for transmitting transformed signals to each line, a call control unit 20 for transforming call control signals generated in the PSTN and the ISDN line to be suitable for the other networks, transmitting the transformed signals, and controlling a media transmission/reception channel according to call processing resource (port and memory) management and call setup, a media data processing unit 30 for transforming and compressing voice data to be suitable for the other networks, and a system utility 40 for managing system resources such as a memory or timer. The operation of the circuit interface unit will now be described in more detail.

The interface unit 10 is influenced by the base structure of a PBX system which the circuit interface unit will be installed in. The interface unit 10 includes a voice data communication interface unit 10a for transforming voice data according to a voice data transmission/reception protocol used in the PBX system, and transmitting/receiving data through a voice data transmission/reception line, a PBX call control signal interface unit 10b for transforming the call control signals used in the PBX system, and transmitting/receiving the transformed signals, an encoding/decoding interface unit 10c for encoding/decoding voice data in a data format suitable for the other networks, and an ISDN interface unit 10d for generating and managing a socket for communication to the ISDN line, and transmitting/receiving data through the socket.

Here, the PBX call control signal interface unit 10b cannot predict a reception point of the call control signals from another node of the PBX, and thus continuously performs an operation (polling) for confirming whether a new signal is received through the line by a PBX call control signal receiving unit 10b1.

The encoding/decoding interface unit 10c is mostly formed in a DSP (Digital Signal Processing) chip type to perform encoding/decoding in a real time. When access interfaces of a sub DSP chip are different, the encoding/decoding interface unit 10c provides properties of the DSP chip interfaces to improve independence of the media data processing unit 30.

The socket of the ISDN interface unit 10d for data transmission/reception is a tool provided by an operating system, and thus should be adjusted according to variations of the operating system.

The ISDN interface unit 10d cannot predict a reception point of the call control requests from the VoIP, and thus continuously performs an operation (polling) for confirming whether a new signal is received through the line by a VoIP call control signal receiving unit 10d1.

In addition, the ISDN interface unit 10d cannot predict a reception point of the ISDN data packet, and thus continuously performs an operation for confirming whether a data packet is received in a socket for ISDN packet data reception by an ISDN packet receiving unit 10d2.

The call control unit 20 processes the call control signals generated in different kinds of networks managed by a gateway, generally multiple calls. Since call setup and call cancellation are processed in a relatively short time and a plurality of calls simultaneously attempt to access a common system resource, the call control unit 20 preferably sequentially processes the calls in one task, not individual tasks.

For this, the call control unit 20 includes a PBX call control signal processing unit 20a for receiving call control requests from the PBX, transforming an internal call status, and transmitting the transformed calls to the VoIP, and receiving call control requests from the VoIP, transforming the internal call status, generating PBX call control signals according to the call control signal mechanism with the PBX, and transmitting the signals to the PBX; a call control signal transforming unit 20b for analyzing the call control signals requested by the PBX and the VoIP to perform an appropriate function of the other call control signal processing units; a VoIP call control signal processing unit 20c for receiving call control requests from the VoIP, transforming the internal call status, and transmitting the transformed signals to the PBX through the call signal transforming unit 20b, and receiving call control requests from the PBX, transforming the internal call status, generating VoIP call control signals according to the call control signal mechanism with the VoIP, and transmitting the signals to the VoIP; a multiple port managing unit 20d for managing ports in the PBX which are physical resources for processing multiple calls; a multiple call control unit 20e for managing resource information of the multiple calls which can be logically processed by a gateway system; and a media transmission/reception control unit 20f for enabling the media data processing unit 30 to perform a proper control operation according to a call setup status.

Here, the multiple port managing unit 20d manages the status of ports which are currently available, ports where calls are being setup, and ports where calls have been set up. The port information can be obtained from the PBX according to kinds of systems. This mechanism is performed by communication with the PBX call control signal interface unit 10b.

In addition, when the calls are being set up, have been set up or are being ended, the media transmission/reception control unit 20f performs resource allocation, data transmission/reception, data transmission/reception interception, and resource deallocation for voice data transmission/reception.

The media data processing unit 30 for generating tasks for each call and processing media data in a real time includes a PBX media data MUX (multiplexer) unit 30a for buffering voice data from the PBX by channels and outputting the buffered data to a CODEC (coder/decoder) processing unit 30b, and buffering voice data from the VoIP and outputting the buffered data to the corresponding channel; an RTP (real-time transport protocol) stack 30c for transmitting/receiving voice data to/from the VoIP; and the CODEC processing unit 30b for transforming voice data from different kinds of networks into voice data formats requested by the other networks.

Here, the CODEC processing unit 30b can transform the voice data into the formats requested by the other networks through software. In this embodiment, the CODEC processing unit 30b uses a hardware DSP chip, and thus can exchange only channel information which will be transformed with the encoding/decoding interface unit 10c by communication.

The ISDN stack 30c transmits/receives voice data through the ISDN line. It cannot predict a reception point of the ISDN voice data, and thus continuously performs an operation for confirming whether a data is received in a socket for RTP reception by the ISDN packet receiving unit 10d2 of the ISDN interface unit 10d.

The system utility 40 is very closely associated with the system, and thus should be adjusted according to variations of the subsystem. The system utility 40 includes a memory managing unit 40a for managing a system memory allowed to users, when the memory needs to be dynamically allocated during system operation, and a timer managing unit 40b for managing a call processing timer, when any operation is not performed within an allowed period of time in call control, or when a plurality of calls exist.

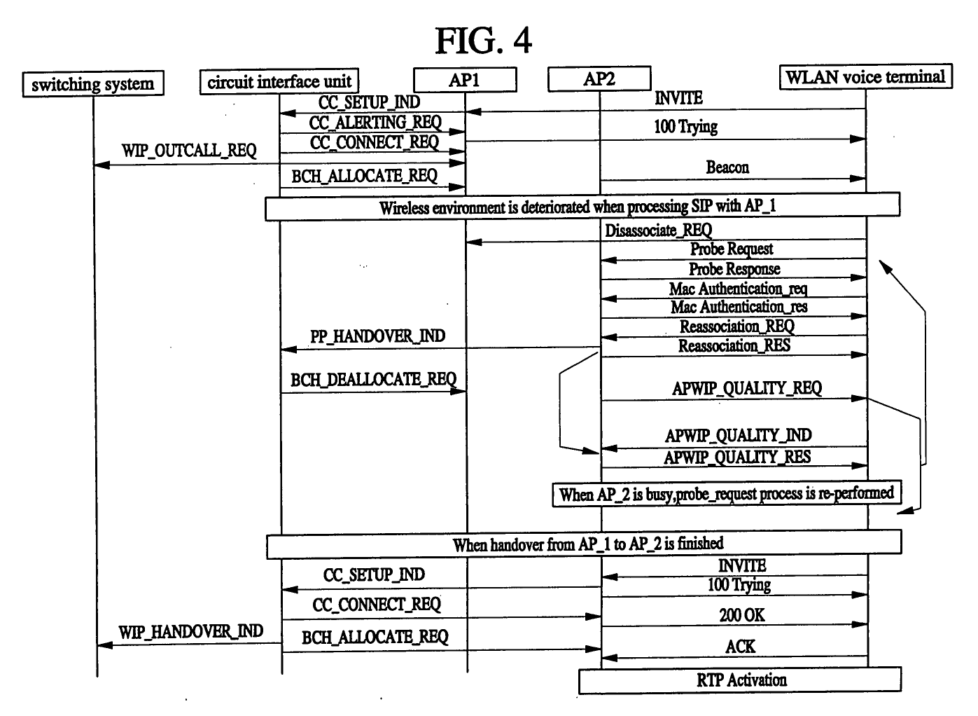

FIG. 4 is a signal flowchart showing the method for supporting mobility of the WLAN voice terminal when it roams between the access points during signaling in accordance with the present invention.

As shown in FIG. 4, the WLAN voice terminal requests association by transmitting an invite signal INVITE to the access point 1 (AP1), and the access point 1 requests call connection by transmitting a call connection setup request signal CC_SETUP_IND to the circuit interface unit.

The circuit interface unit transmits a call connection alert request signal CC_ALERTING_REQ to the access point 1.

The access point 1 receiving the call connection alert request signal CC_ALERTING_REQ attempts call connection by transmitting a 100 trying signal to the WLAN voice terminal.

The circuit interface unit requests call connection by transmitting a call connection setup request signal CC_CONNECT_REQ to the access point 1, requests out call processing by transmitting an out call processing request signal WIP_OUTCALL_REQ to the switching system, and requests channel allocation by transmitting a B channel allocation request signal BCH_ALLOCATE_REQ to the access point 1.

Here, when the WLAN voice terminal roams from the BSA of the access point 1 (AP1) to the BSA of the access point 2 (AP2), the WLAN voice terminal receives the beacon from the access point 2, transmits a probe request signal Probe Request to the access point 2, and receives a probe response signal Probe Response from the access point 2.

Thereafter, the WLAN voice terminal requests MAC authentication to the access point 2 by transmitting a MAC authentication request signal Mac Authentication_req including a MAC address to the access point 2. Here, the access point 2 must receive MAC address information of the WLAN voice terminal from the switching system and store it to authenticate the WLAN voice terminal by using the MAC address.

The access point 2 authenticates the WLAN voice terminal by using the MAC address. When the access point 2 can be associated with the WLAN voice terminal, it transmits a MAC authentication completion response signal Mac Authentication_res to the WLAN voice terminal.

When the WLAN voice terminal requests re-association by transmitting a re-association request signal Reassociation_REQ to the access point 2, the access point 2 requests handover by transmitting a handover request signal PP_HANDOVER_IND to the circuit interface unit.

At this time, the re-association request signal Reassociation_REQ which the WLAN voice terminal transmits to the access point 2 includes MAC address information of the access point 1.

In addition, the handover request signal PP_HANDOVER_IND which the access point 2 transmits to the circuit interface unit includes MAC address information of the WLAN voice terminal, IP address information of the WLAN voice terminal, and MAC address information of the access point 1.

When the B channel has not been allocated, the circuit interface unit receiving the handover request signal PP_HANDOVER_IND including the MAC address information of the WLAN voice terminal, IP address information of the WLAN voice terminal, and MAC address information of the access point 1 from the access point 2 performs signal handover to disassociate the access point 1 from the WLAN voice terminal.

When the B channel has been allocated, the circuit interface unit performs voice handover, transmits a B channel deallocation request signal BCH_DEALLOCATE_REQ to the access point 1, and deallocates the previously-allocated B channel, thereby disassociating the access point 1 from the WLAN voice terminal.

The B channel deallocation request signal BCH_DEALLOCATE_REQ which the circuit interface unit transmits to the access point 1 includes an IP address and phone number of the WLAN voice terminal.

The access point 2 requests association by transmitting a re-association request response signal Reassociation_RES to the WLAN voice terminal.

In addition, the access point 2 provides additional information of its own status, whether its current status is idle or busy to the WLAN voice terminal according to a broadcasting method.

When the access point 2 receives an access point status request signal APWIP_QUALITY_REQ requesting information of its own status from the WLAN voice terminal, the access point 2 transmits the information of its own status to the WLAN voice terminal by using an access point status response signal APWIP_QUALITY_RES.

When the access point 2 is busy, the WLAN voice terminal re-performs the operation for tracking another access point.

On the other hand, when handover from the access point 1 to the access point 2 has been finished, the WLAN voice terminal requests association by transmitting the invite signal INVITE to the access point 2, and the access point 2 requests call connection by transmitting the call connection setup request signal CC_SETUP_IND to the circuit interface unit.

The access point 2 attempts call connection by transmitting the 100 trying signal to the WLAN voice terminal.

When receiving the call connection setup request signal CC_SETUP_IND by Re-Invite, the circuit interface unit recognizes completion of the handover, requests call connection by transmitting the call connection setup request signal CC_CONNECT_REQ to the access point 2, requests handover by transmitting a handover request signal WIP_HANDOVER_IND to the switching system, and requests channel allocation by transmitting the B channel allocation request signal BCH_ALLOCATE_REQ to the access point 2.

The access point 2 receiving the B channel allocation request signal BCH_ALLOCATE_REQ from the circuit interface unit allocates the B channel. When receiving a response signal from the WLAN voice terminal, the access point 2 performs voice communication using data packets according to an RTP protocol.

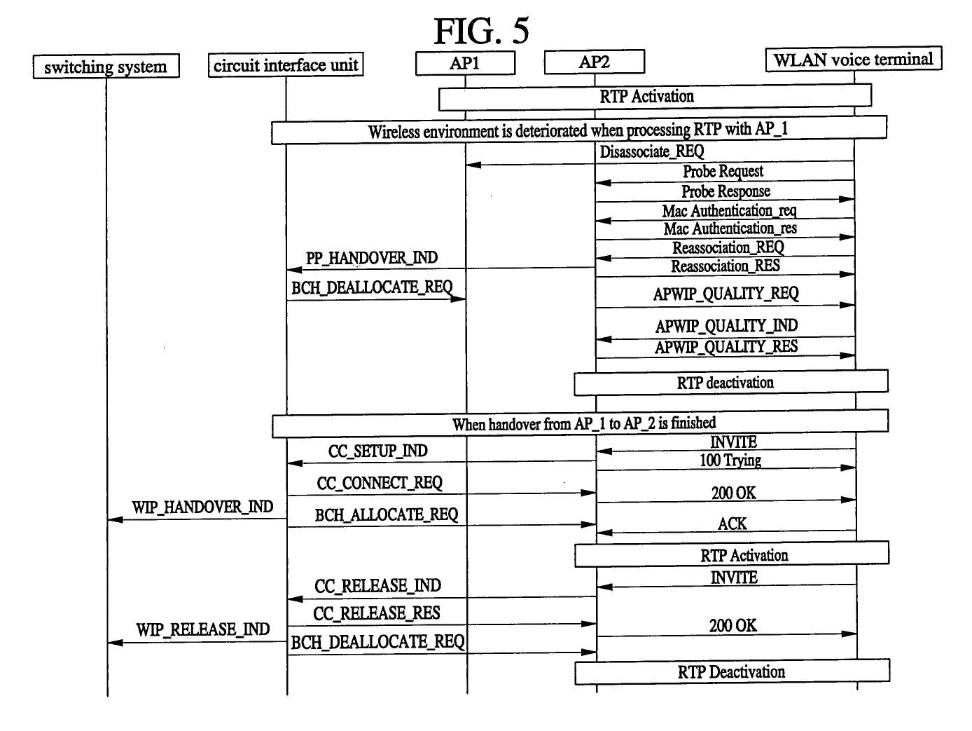

FIG. 5 is a signal flowchart showing the method for supporting mobility of the WLAN voice terminal when it roams between the access points during an active call in accordance with the present invention.

Referring to FIG. 5, when the wireless environment of the access point 1 and the WLAN voice terminal is deteriorated during the voice packet data communication according to the RTP protocol, the WLAN voice terminal transmits a disassociation request signal Disassociation_REQ to the access point 1.

The WLAN voice terminal transmits a probe request signal Probe Request to the access point 2, and receives a probe response signal Probe Response from the access point 2.

The WLAN voice terminal requests MAC authentication to the access point 2 by transmitting a MAC authentication request signal Mac Authentication_req including a MAC address to the access point 2. Here, the access point 2 must receive MAC address information of the WLAN voice terminal from the switching system and store it to authenticate the WLAN voice terminal by using the MAC address.

The access point 2 authenticates the WLAN voice terminal by using the MAC address. When the access point 2 can be associated with the WLAN voice terminal, it transmits a MAC authentication completion response signal Mac Authentication_res to the WLAN voice terminal.

When the WLAN voice terminal requests re-association by transmitting a re-association request signal Reassociation_REQ to the access point 2, the access point 2 requests handover by transmitting a handover request signal PP_HANDOVER_IND to the circuit interface unit.

At this time, the re-association request signal Reassociation_REQ which the WLAN voice terminal transmits to the access point 2 includes MAC address information of the access point 1.

In addition, the handover request signal PP_HANDOVER_IND which the access point 2 transmits to the circuit interface unit includes MAC address information of the WLAN voice terminal, IP address information of the WLAN voice terminal, and MAC address information of the access point 1.

When the B channel has not been allocated, the circuit interface unit receiving the handover request signal PP_HANDOVER_IND from the access point 2 performs signal handover to disassociate the access point 1 from the WLAN voice terminal.

When the B channel has been allocated, the circuit interface unit performs voice handover, transmits a B channel deallocation request signal BCH_DEALLOCATE_REQ to the access point 1, and deallocates the previously-allocated B channel.

The access point 2 transmits a re-association request response signal Reassociation_RES to the WLAN voice terminal, and provides additional information of its own status, whether its current status is idle or busy to the WLAN voice terminal according to the broadcasting method.

When the access point 2 receives an access point status request signal. APWIP_QUALITY_REQ requesting information of its own status from the WLAN voice terminal, the access point 2 transmits the information of its own status to the WLAN voice terminal by using an access point status response signal APWIP_QUALITY_RES.

When the access point 2 is busy, the WLAN voice terminal re-performs the operation for tracking another access point.

On the other hand, when handover from the access point 1 to the access point 2 has been finished, the WLAN voice terminal requests association by transmitting an invite signal INVITE to the access point 2, and the access point 2 requests call connection by transmitting a call connection setup request signal CC_SETUP_IND to the circuit interface unit.

The access point 2 attempts call connection by transmitting a 100 trying signal to the WLAN voice terminal.

When receiving the call connection setup request signal CC_SETUP_IND by Re-Invite, the circuit interface unit recognizes completion of the handover, requests call connection by transmitting a call connection setup request signal CC_CONNECT_REQ to the access point 2, and requests handover by transmitting a handover request signal WIP_HANDOVER_IND to the switching system.

In addition, the circuit interface unit requests channel allocation by transmitting a B channel allocation request signal BCH_ALLOCATE_REQ to the access point 2.

Here, the access point 2 receiving the B channel allocation request signal BCH_ALLOCATE_REQ from the circuit interface unit allocates the B channel. When receiving a response signal from the WLAN voice terminal, the access point 2 performs voice packet data communication according to the RTP protocol.

On the other hand, when the WLAN voice terminal transmits the invite signal INVITE during the voice packet data communication according to the RTP protocol, the access point 2 transmits a call connection release request signal CC_RELEASE_IND to the circuit interface unit.

Thereafter, the circuit interface unit transmits a call connection release response signal CC_RELEASE_RES and a B channel deallocation request signal BCH_DEALLOCATE_REQ to the access point 2, and deallocates the previously-allocated channel, to intercept call connection.

The present invention can be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The present invention can include the computer-readable medium having stored thereon a data structure including a plurality of fields containing data representing the techniques of the present invention.

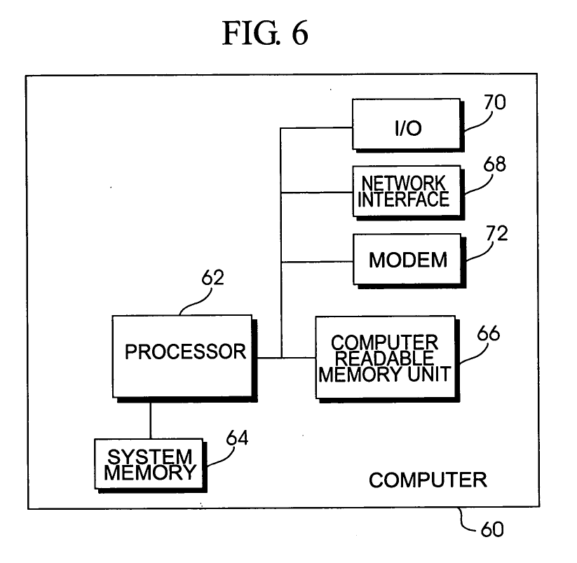

An example of a computer, but not limited to this example of the computer, that can read computer readable media that includes computer-executable instructions of the present invention is shown in FIG. 6. The computer 600 includes a processor 602 that controls the computer 600. The processor 602 uses the system memory 604 and a computer readable memory device 606 that includes certain computer readable recording media. A system bus connects the processor 602 to a network interface 608, modem 612 or other interface that accommodates a connection to another computer or network such as the Internet. The system bus may also include an input and output interface 610 that accommodates connection to a variety of other devices.

While the invention has been shown and described with reference to certain preferred embodiments thereof, it will be understood by those skilled in the art that various changes in form and details may be made therein without departing from the spirit and scope of the invention as defined by the appended claims.

As discussed earlier, in accordance with the present invention, the method for supporting mobility of the WLAN voice terminal can guarantee mobility and quality of voice, when the WLAN voice terminal roams from the BSS of one access point to the BSS of another access point during signaling.

Moreover, the method for supporting mobility of the WLAN voice terminal can guarantee mobility and quality of voice, when the WLAN voice terminal roams from the BSS of one access point to the BSS of another access point during the active call.

What is claimed is:

1. A method for supporting mobility of a wireless local area network voice terminal using a data line, comprising:
performing a probe process during association signaling between the wireless local area network voice terminal and a first access point where the wireless local area network voice terminal roams to a second access point;
performing a media access control address authentication process by the wireless local area network voice terminal and the second access point;
performing by a circuit interface unit, handover by using terminal information of the wireless local area network voice terminal and media access control address information of the first access point upon the re-association request of the wireless local area network voice terminal through the second access point; and
performing an association signaling process after the handover by the wireless local area network voice terminal and the second access point.

2. The method of claim 1, further comprising of transmitting by the second access point, additional information to the wireless local area network voice terminal, when the second access point receives a re-association request signal from the wireless local area network voice terminal in the step of performing the handover by the circuit interface unit.

3. The method of claim 2, wherein the additional information which the second access point transmits to the wireless local area network voice terminal is status information notifying whether the current status of the second access point is busy or idle.

4. The method of claim 1, wherein the association signaling between the wireless local area network voice terminal and the first access point in the step of performing a probe process during association signaling comprises:
requesting by the first access point, a call connection by transmitting a call connection setup request signal to the circuit interface unit, when the wireless local area network voice terminal requests association to the first access point;
transmitting by the circuit interface unit, a call connection alert signal to the first access point;
attempting to be associated with the wireless local area network voice terminal by the first access point, when it receives the call connection alert signal from the circuit interface unit;
requesting by the circuit interface unit, a call connection setup to the first access point, and also requesting by the circuit interface unit of a outcall processing to the switching system; and
requesting by the circuit interface unit, a channel allocation by transmitting a channel allocation request signal to the first access point.

5. The method of claim 1, wherein the step of performing the media access control address authentication process comprises:
transmitting by the wireless local area network voice terminal, a media access control authentication request signal including a media access control address to the second access point;
performing authentication by using stored media access control address information by the second access point; and
transmitting by the second access point, a media access control authentication completion response signal to the wireless local area network voice terminal, when the wireless local area network voice terminal can be associated with the second access point as a result of authentication.

6. The method of claim 1, wherein the step of performing the handover by the circuit interface unit, comprises:
transmitting a re-association request signal including a media access control address of the first access point to the second access point by the wireless local area network voice terminal;
requesting handover by the second access point by transmitting media access control address information of the first access point, and media access control address information and Internet protocol address information of the wireless local area network voice terminal to the circuit interface unit;
receiving the handover request signal from the second access point by the circuit interface unit confirming whether a B channel has been allocated to the first access point; and
requesting by the circuit interface unit channel, deallocation to the first access point and deallocating the allocated B channel by performing signal handover when the B channel has not been allocated to the first access point, and performing voice handover, when the B channel has been allocated to the first access point.

7. The method of claim 1, wherein the step of performing the association signaling process, comprises:
requesting by the second access point, call connection by transmitting a call connection setup request signal to the circuit interface unit, when the wireless local area network voice terminal requests association to the second access point;
transmitting a call connection alert signal to the second access point by the circuit interface unit;
attempting to be associated with the wireless local area network voice terminal by the second access point, when the second access point receives the call connection alert signal from the circuit interface unit;
requesting call connection setup to the second access point, and requesting outcall processing to the switching system by the circuit interface unit;
requesting by the circuit interface unit, a channel allocation by transmitting a channel allocation request signal to the second access point;
allocating a B channel and transmitting a success message to the wireless local area network voice terminal by the second access point; and
setting up a call and providing voice communication by the second access point, when the second access point receives a final response signal from the wireless local area network voice terminal.

8. The method of claim 1, wherein the association signaling between the wireless local area network voice terminal and the first access point in the step of performing a probe process during association signaling comprises:
requesting a call connection by the first access point, when the wireless local area network voice terminal requests association to the first access point;
attempting to be associated with the wireless local area network voice terminal by the first access point, when the first access point receives the call connection alert signal from the circuit interface unit;
requesting a call connection setup to the first access point by the circuit interface unit; and
requesting by the circuit interface unit, a channel allocation by transmitting a channel allocation request signal to the first access point.

9. The method of claim 8, wherein the performing of the media access control address authentication process comprises:
transmitting a media access control authentication request signal including a media access control address to the second access point;
performing authentication by using stored media access control address information; and
transmitting a media access control authentication completion response signal to the wireless local area network voice terminal, when the wireless local area network voice terminal can be associated with the second access point as a result of authentication.

10. The method of claim 9, wherein the performing of the handover, comprises:
transmitting a re-association request signal including a media access control address of the first access point to the second access point;
requesting handover by transmitting media access control address information of the first access point, and media access control address information and Internet protocol address information of the wireless local area network voice terminal to the circuit interface unit; and
receiving the handover request signal confirming whether a B channel has been allocated to the first access point.

11. The method of claim 10, wherein the performing of the association signaling process, comprises:
requesting a call connection by transmitting a call connection setup request signal to the circuit interface unit, when the wireless local area network voice terminal requests association to the second access point;
attempting to be associated with the wireless local area network voice terminal by the second access point, when the second access point receives the call connection alert signal from the circuit interface unit;
requesting call connection setup to the second access point, and requesting outcall processing to the switching system by the circuit interface unit;
requesting by the circuit interface unit, a channel allocation by transmitting a channel allocation request signal to the second access point; and
setting up a call and providing voice communication by the second access point, when the second access point receives a final response signal from the wireless local area network voice terminal.

12. A method for supporting mobility of a wireless local area network voice terminal using a data line, comprising:
performing a probe process during an active call between the wireless local area network voice terminal and a first access point where the wireless local area network voice terminal roams to a second access point;
performing a media access control address authentication process by the wireless local area network voice terminal and the second access point;
performing a handover by a circuit interface unit by using terminal information of the wireless local area network voice terminal and media access control address information of the first access point upon the re-association request of the wireless local area network voice terminal through the second access point;
performing an association signaling process after performing the handover by the wireless local area network voice terminal and the second access point; and
setting up a call and providing voice communication by the second access point after the association signaling process.

13. The method of claim 12, further comprising of transmitting additional information to the wireless local area network voice terminal by the second access point, when the second access point receives a re-association request signal from the wireless local area network voice terminal in the step of performing the handover.

14. The method of claim 13, wherein the additional information which the second access point transmits to the wireless local area network voice terminal is status information notifying whether the current status of the second access point is busy or idle.

15. The method of claim 12, wherein the step of performing the media access control address authentication process comprises:
transmitting a media access control authentication request signal including a media access control address to the second access point by the wireless local area network voice terminal;
authenticating the wireless local area network voice terminal by using stored media access control address information by the second access point; and
transmitting a media access control authentication completion response signal to the wireless local area network voice terminal by the second access point, when the wireless local area network voice terminal can be associated with the second access point as a result of authentication.

16. The method of claim 12, wherein the step of performing the handover comprises:
transmitting a re-association request signal including a media access control address of the first access point to the second access point by the wireless local area network voice terminal;
requesting handover by the second access point by transmitting media access control address information of the first access point, and media access control address information and Internet protocol address information of the wireless local area network voice terminal to the circuit interface unit;
receiving the handover request signal from the second access point confirming by the circuit interface unit whether a B channel has been allocated to the first access point; and
requesting channel deallocation to the first access point and deallocating the allocated B channel by the circuit interface unit by performing signal handover when the B channel has not been allocated to the first access point, and performing voice handover, when the B channel has been allocated to the first access point.

17. The method of claim 12, wherein the step of performing the association signaling process comprises:
requesting call connection by transmitting a call connection setup request signal to the circuit interface unit by the second access point, when the wireless local area network voice terminal requests association to the second access point;
transmitting a call connection alert signal to the second access point by the circuit interface unit;
attempting to be associated with the wireless local area network voice terminal by the second access point, when it receives the call connection alert signal from the circuit interface unit;
requesting call connection setup to the second access point and requesting outcall processing to the switching system by the circuit interface unit;
requesting channel allocation by transmitting a channel allocation request signal to the second access point by the circuit interface unit;
allocating a B channel and transmitting a success message to the wireless local area network voice terminal by the second access point; and
setting up a call and providing voice communication by the second access point, when the second access point receives a final response signal from the wireless local area network voice terminal.

18. An apparatus for supporting mobility of a wireless local area network voice terminal using a data line, comprising:
a plurality of access points including a first and second access points;
the wireless local area network voice terminal roams to the second access point and performs a probe process during association signaling between the wireless local area network voice terminal and the first access point, the wireless local area network voice terminal and the second access point perform a media access control address authentication process; and
a circuit interface unit performs handover by using terminal information of the wireless local area network voice terminal and media access control address information of the first access point upon the re-association request of the wireless local area network voice terminal through the second access point, the wireless local area network voice terminal and the second access point perform an association signaling process after the handover.

19. The method of claim 18, wherein the second access point transmits additional information to the wireless local area network voice terminal, when the second access point receives a re-association request signal from the wireless local area network voice terminal in the step of performing the handover by the circuit interface unit.

20. The method of claim 19, wherein the additional information which the second access point transmits to the wireless local area network voice terminal is status information notifying whether the current status of the second access point is busy or idle.

21. A method, comprising:
performing a probe process during an active call between a terminal and a first access point where the voice terminal roams to a second access point;
performing a media access control address authentication process by the terminal and the second access point;
performing a handover by an interface unit by using terminal information of the terminal and media access control address information of the first access point upon the re-association request of the wireless local area network voice terminal through the second access point;
performing an association signaling process after performing the handover by the terminal and the second access point; and
setting up a call and providing voice communication by the second access point after the association signaling process.

22. The method of claim 21, further comprising of transmitting additional information to the terminal by the second access point, when the second access point receives a re-association request signal from the terminal in the step of performing the handover.

23. The method of claim 22, wherein the additional information which the second access point transmits to the terminal is status information notifying whether the current status of the second access point is busy or idle.

24. The method of claim 23, wherein the performing of the media access control address authentication process comprises:
transmitting a media access control authentication request signal including a media access control address to the second access point by terminal;
authenticating the terminal by using stored media access control address information by the second access point; and
transmitting a media access control authentication completion response signal to the terminal by the second access point, when the wireless local area network voice terminal can be associated with the second access point as a result of authentication.

25. The method of claim 24, wherein the performing of the handover comprises:
transmitting a re-association request signal including a media access control address of the first access point to the second access point by the terminal;
requesting handover by the second access point by transmitting media access control address information of the first access point;
receiving the handover request signal from the second access point confirming by the interface unit whether a first channel has been allocated to the first access point; and
requesting channel deallocation to the first access point and deallocating the allocated first channel by the interface unit by performing signal handover when the first channel has not been allocated to the first access point, and performing voice handover, when the first channel has been allocated to the first access point.

26. The method of claim 25, wherein the performing of the association signaling process comprises:
requesting call connection by transmitting a call connection setup request signal to the interface unit by the second access point, when the wireless local area network voice terminal requests association to the second access point;
transmitting a call connection alert signal to the second access point by the interface unit;
attempting to be associated with the terminal by the second access point, when the second access point receives the call connection alert signal from the interface unit;
requesting call connection setup to the second access point and requesting outcall processing to the switching system by the interface unit;
requesting channel allocation by transmitting a channel allocation request signal to the second access point by the interface unit;
allocating the first channel and transmitting a success message to the terminal by the second access point; and
setting up a call and providing voice communication by the second access point, when the second access point receives a final response signal from the terminal.

27. A computer-readable medium having computer-executable instructions for performing a method, comprising:
performing a probe process during an active call between a terminal and a first access point where the voice terminal roams to a second access point;
performing a media access control address authentication process by the terminal and the second access point;
performing a handover by an interface unit by using terminal information of the terminal and media access control address information of the first access point upon the re-association request of the wireless local area network voice terminal through the second access point;
performing an association signaling process after performing the handover by the terminal and the second access point; and
setting up a call and providing voice communication by the second access point after the association signaling process.

28. A computer-readable medium having stored thereon a data structure comprising:
a first field containing data representing performing a probe process during association signaling between the wireless local area network voice terminal and a first access point where the wireless local area network voice terminal roams to a second access point;
a second field containing data representing performing a media access control address authentication process by the wireless local area network voice terminal and the second access point;
a third field containing data representing performing by a circuit interface unit, handover by using terminal information of the wireless local area network voice terminal and media access control address information of the first access point upon the re-association request of the wireless local area network voice terminal through the second access point; and
a fourth field containing data representing performing an association signaling process after the handover by the wireless local area network voice terminal and the second access point.
